(19) United States
(12) Patent Application Publication
(10) Pub. No.: US 2021/0110749 A1
(43) Pub. Date: Apr. 15, 2021

(54) LASER LIGHT OUTPUT CONTROL DEVICE AND LASER SCANNING DISPLAY DEVICE

(71) Applicant: NIPPON SEIKI CO., LTD., Niigata (JP)

(72) Inventor: Makoto HADA, Niigata (JP)

(21) Appl. No.: 16/965,085

(22) PCT Filed: Feb. 15, 2019
(86) PCT No.: PCT/JP2019/005485

§ 371 Date: Jul. 27, 2020

(30) Foreign Application Priority Data
Feb. 26, 2018 (JP) 2018-032573

(51) Int. Cl. G09G 3/02; G09G 5/10; G02B 26/10; G02B 27/01

(52) U.S. Cl. CPC G09G 3/025; G09G 5/10; G02B 26/101; G02B 27/0101; G09G 2360/144; B60K 35/00; G09G 2310/08; G09G 2320/0633; G09G 2380/10; G02B 2027/0118; G09G 2360/141

(57) ABSTRACT

The purpose of the present invention is to prevent stray light from reducing display quality. Provided is a laser light output control device that provides feedback on the intensity of the laser light emitted by a light source to thereby adjust the control value used by the light source to display an image M, wherein: an illuminance determination unit acquires an illuminance signal that allows estimation of the illuminance in the ambient environment or acquires a request luminance signal that externally controls the luminance of the image M, and determines the brightness of the ambient environment; an inspection time adjustment unit shortens a period Q during which the lights source emits inspection light Cd when the illuminance determination unit determines that there is a dark ambient environment, compared to when there is a bright ambient environment; and a light source control unit acquires an integrated value Sd of the intensity of the inspection light Cd emitted by the light source and adjusts a control value for driving the light source.

### TECHNICAL FIELD

The present invention relates to a laser light output control device that controls a laser light source, and a laser scanning display device that generates an image by two-dimensionally scanning the light emitted from this laser light output control device.

### BACKGROUND ART

The laser scanning display device is, for example, a device in which a scanning unit scans a laser light emitted by a laser light output control device onto a screen to thereby generate an image. Such a laser scanning display device has a problem in that the light intensity of the emitted light changes due to temperature changes in an operating environment and the generated image is not displayed with a desired luminance and a desired color.

In order to solve such a problem, there is known a technique that detects the light intensity of a laser light and adjusts the output of the laser light on the basis of the detected light intensity, thereby outputting desired light intensity.

In addition, Patent Document 1 discloses a technique in which a reflection/transmission unit that receives light from a light source, reflects part of the light as reflected light in the direction of an optical sensor, and transmits part of the light as transmitted light to a scanning unit side is included, and the reflected light of the light output from the light source is caused to enter the optical sensor, and the drive of the light source is corrected on the basis of a detection signal of the optical sensor. The light detected by the optical sensor is the reflected light (reflected light of a detection light) of the light (detection light) emitted by the light source driven with predetermined output intensity (control value). This detection light is output when the scanning unit directs a laser light to an invisible area on a screen, that cannot be visually recognized by a user.

The scanning unit of the laser scanning display device scans a laser light emitted from the light source in a main scanning direction in a lateral direction a plurality of times while sub-scanning the laser light in a vertical direction orthogonal to the main scanning direction. The area that can be scanned by the scanning unit includes a visible area that can be visually recognized by a user and an invisible area that is hard to be visually recognized by the user otherwise. Typically, the visible area is a rectangular area located approximately in the center of an area scannable by the scanning unit, and the invisible area is a hollow rectangular area that surrounds the visible area including the outside of both ends in the lateral direction (main scanning direction) of the visible area and the outside of both ends in the vertical direction (sub-scanning direction) of the visible area.

As mentioned above, the inspection light is output when the scanning unit is directing the laser light to the area on the screen, that cannot be visually recognized by the user. Thus, the inspection light scanned on the screen should not be visible from the user. However, in reality, part of the inspection light projected to the invisible area of the screen becomes stray light due to the diffusion and irregular reflection in the screen, and becomes visible to the user.

In order to project the inspection light to a position away from the visible area on the screen, that is visually recognized by the user in such a manner that the stray light of the inspection light is not visually recognized by the user, Patent Document 2 discloses a technique for causing a light source to emit an inspection light in the vicinity of a reciprocation switching point in a sub-scanning direction.

### PRIOR ART DOCUMENT

### Patent Document

Patent Document 1: Japanese Patent Application Laid-Open No. 2014-086426

Patent Document 2: WO 2017/145859

### SUMMARY OF THE INVENTION

### Problems to be Solved by the Invention

However, in order to separate the visible area on the screen from the area to which the inspection light is emitted, it is necessary to provide a large invisible area on the screen that is not visually recognized by the user, and it is necessary to enlarge the screen. In addition, enlarging the invisible area shortens the time taken to scan the visible area out of the total scanning time by the scanning unit, and thus there is a risk that display efficiency could be reduced.

Therefore, the present invention provides a laser light output control device that suppresses deterioration of display quality due to stray light, and a laser scanning display device using this laser light output control device.

### Solution to Problem

A laser scanning display device in a first embodiment is a laser light output control device (101) to provide feedback on light intensity of a laser light emitted by a light source (11) to thereby adjust a control value of the light source (11) for displaying an image (M). The laser light output control device (101) includes an illuminance determination unit (21) that acquires an illuminance signal allowing estimation of an illuminance in an ambient environment or a required luminance signal externally controlling a luminance of the image (M) and determines brightness of the ambient environment; an inspection time adjustment unit (22) that shortens a period (Q) during which the light source (11) emits an inspection light (Cd) when the illuminance determination unit (21) determines that the ambient environment is dark, compared to when the ambient environment is bright; and a light source control unit (23) that acquires an integrated value (Sd) of light intensity of the inspection light (Cd) emitted by the light source (11) and adjusts the control value that drives the light source (11).

### Effect of the Invention

The present invention can suppress deterioration of display quality due to stray light.

### BRIEF DESCRIPTION OF THE DRAWINGS

FIG. 1 is a diagram for explaining an aspect in which a head-up display device according to an embodiment of the present invention is mounted.

FIG. 2 is a diagram illustrating an example of a schematic cross section of the head-up display device of the above embodiment.

FIG. 3 is a diagram illustrating an example of a schematic cross section of a laser light output unit of the above embodiment.

FIG. 4 is a block diagram illustrating an electrical configuration of the laser light output unit of the above embodiment.

FIG. 5 is a diagram illustrating an example of an aspect of scanning on a screen in a laser scanning display device of the above embodiment.

FIG. 6(a) is a diagram illustrating a time transition of a sub-scanning position. FIG. 6(b) is a diagram illustrating an emission time of an inspection light corresponding to the time transition of FIG. 6(a). FIG. 6(c) is a diagram illustrating an example of a detection signal corresponding to the time transition of FIG. 6(a).

FIG. 7(a) is a diagram illustrating a time transition of a sub-scanning position. FIG. 7(b) corresponds to the time transition of FIG. 6(a) and is a diagram illustrating an emission time of the inspection light when a surrounding environment is bright. FIG. 6(c) corresponds to the time transition of FIG. 6(a) and is a diagram illustrating an example of the detection signal when the surrounding environment is dark.

FIG. 8 is a flowchart illustrating an example of a light intensity correction process performed by the control unit of the above embodiment.

### MODE FOR CARRYING OUT THE INVENTION

Hereinafter, an embodiment according to the present invention will be described with reference to the drawings. The present invention is not limited to the following embodiment (including the content of the drawings). Modifications (including deletion of components) can be added to the following embodiment. In addition, in the following description, in order to facilitate understanding of the present invention, description of publicly known technical features is omitted as appropriate.

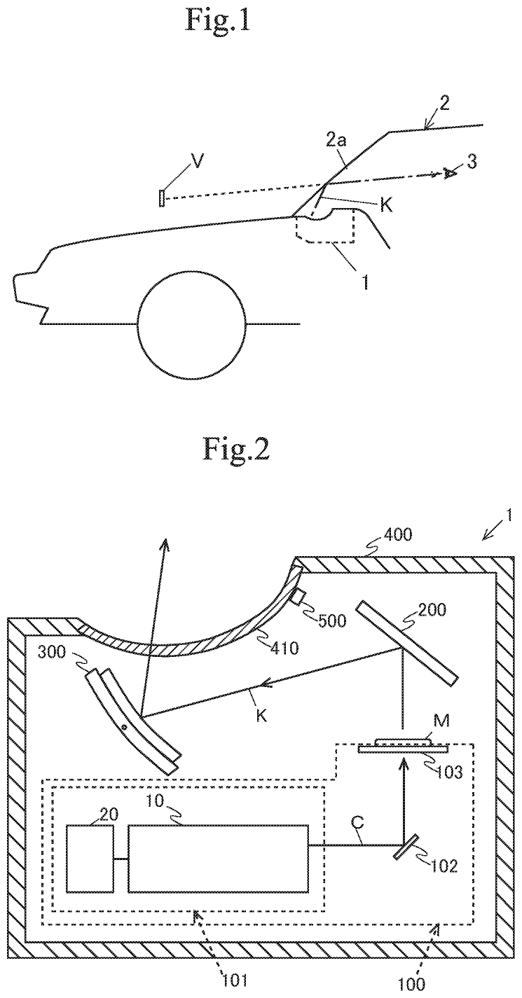

A head-up display device (HUD device) 1 according to the present embodiment is, as illustrated in FIG. 1, installed in a dash board of a vehicle 2 and emits a display light K representing an image M (see FIG. 2) for notifying predetermined information toward a windshield (an example of a transmissive/reflective unit) 2a. The display light K reflected by the front windshield 2a is visually recognized by an observer 3 (mainly a driver of the vehicle 2) as a virtual image V formed in front of the front windshield 2a.

As illustrated in FIG. 2, the HUD device 1 in FIG. 1 includes an image generation unit (laser scanning display device) 100 that generates the image M, a first reflection unit 200 and a second reflection unit 300, which are relay optical units that direct the display light K of the image M generated by the image generation unit 100 toward the front windshield 2a, a housing 400 in which these image generation unit 100, first reflection unit 200, second reflection unit 300, and the like are housed, and an external light sensor 500 that detects an external illuminance of the HUD device 1.

The first reflection unit (relay optical unit) 200 and the second reflection unit (relay optical unit) 300 in FIG. 2 includes, for example, flat or curved mirrors, and receive the display light K representing the image M displayed on a screen 103 and reflect the display light K toward the front windshield 2a. The second reflection unit 300 having a concave surface typically has a function to enlarge the image M generated by the image generation unit 100, a function to correct the distortion of the front windshield 2a and allow the virtual image V to be visually recognized without distortion, a function to form the virtual image V at a position that is a predetermined distance from a user, and the like. In the present embodiment, while the relay optical unit is two reflective optical members, the first reflection unit 200 and the second reflection unit 300, for example, one reflective relay optical unit (second reflection unit 300) may be omitted, or an other reflective relay optical unit may be added. In addition, the relay optical unit is not limited to the reflective relay optical unit, and may be replaced or combined with a refraction type or a diffraction type such as a lens.

The housing 400 houses a laser light output unit 101, a scanning unit 102, the screen 103, the first reflection unit 200, the second reflection unit 300, and the like, includes a light-shielding member, and includes a light transmission unit 410 that transmits the display light K. In addition, for example, the external light sensor 500 is arranged on an inner surface of the light transmission unit 410, and this external light sensor 500 detects an external illuminance of the HUD device 1 and outputs information regarding the external illuminance to a control unit 20 described below.

(Image Generation Unit [Laser Scanning Display Device] 100)

The image generation unit 100 generates the image M on the display surface (screen 103) by two-dimensionally scanning a laser light. The image generation unit 100 mainly includes, for example, a laser light output unit 101 that emits a combined laser light C, a scanning unit 102 that scans the combined laser light C emitted by the laser light output unit 101, and a screen 103 that receives the combined laser light C scanned by this scanning unit 102 and displays the image M.

The laser light output unit 101 emits a combined laser light C described below toward the scanning unit 102, and includes, for example, the laser light output unit 10, a light source 11, and a control unit 20 that controls the light source 11 included in the laser light output unit 10, which will be described below, as well as the scanning unit 102 and the like.

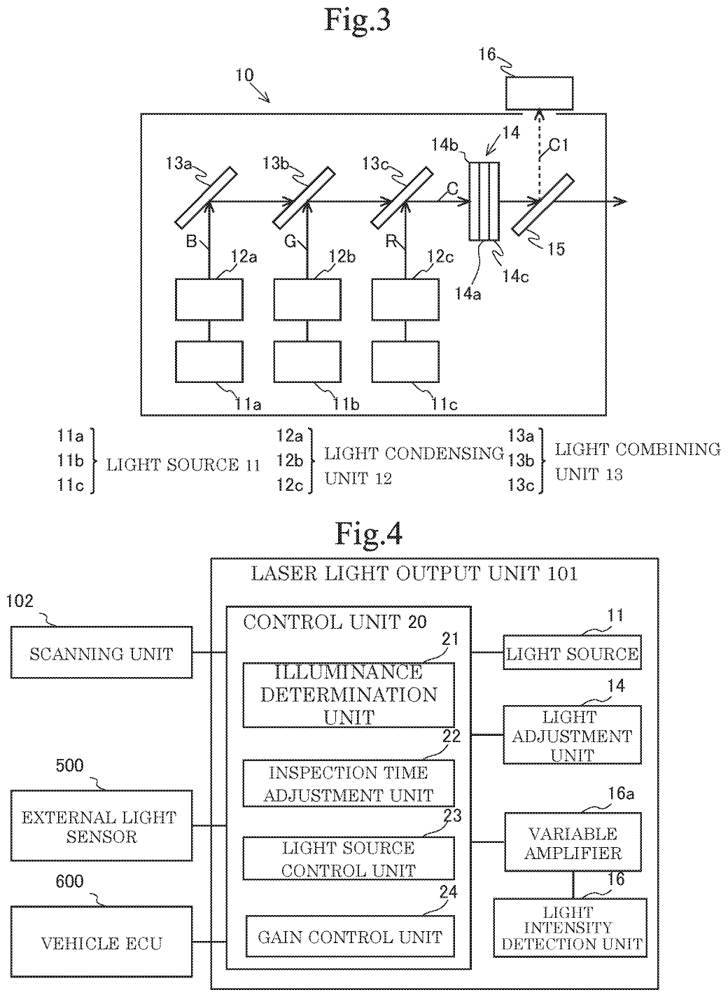

FIG. 3 is a diagram illustrating an example of a configuration of the laser light output unit 10. The laser light output unit 10 mainly includes a light source 11, a light condensing unit 12, a light combining unit 13, a light adjustment unit 14, and a light branching unit 15, a light intensity detection unit 16, and the control unit (laser light output control device) 20.

The light source 11 in FIG. 3 includes a plurality of light sources that emit different colored light, for example, a first light source 11a that emits a blue laser light B, a second light source lib that emits a green laser light G, and a third light source 11c that emits a red laser light R. Specifically, for example, the light source 11 can output light intensity of 256 gradations for each color, and emits a laser light with desired light intensity on the basis of a control value determined by the control unit 20 described below.

The light condensing unit 12 in FIG. 3 condenses the laser lights B, G, and R emitted by the respective light sources 11a, 11b, and 11c and reduces a spot diameter to make a converged light, and includes, for example, a first condensing unit 12a that is located on the optical path of the blue laser light B emitted from the first light source 11a and that condenses the blue laser light B, a second condensing unit 12b that is located on the optical path of the green laser light G emitted from the second light source lib and that condenses the green laser light G, and a third condensing unit 12c that is located on the optical path of the red laser light R emitted from the third light source 11c and that condenses the red laser light R.

The light combining unit 13 in FIG. 3 combines, an optical axis of each laser light B, G, and R emitted from each light source 11a, 11b, and 11c and reaching through the light condensing unit 12, to emit as the combined laser light C, and includes a first light combining unit 13a that adjusts the optical axis of the blue laser light B, a second light combining unit 13b that adjusts the optical axis of the green laser light G, and a third light combining unit 13c that adjusts the optical axis of the red laser light R.

The light adjustment unit 14 in FIG. 3 includes, for example, a VA Vertical alignment (VA) type liquid crystal element 14a and two absorption type or reflection type polarization filters (polarizing plates) 14b and 14c sandwiching this liquid crystal element 14a. The light adjustment unit 14 drives the liquid crystal element 14a by a pulse amplitude modulation (PAM) method or a pulse width modulation (PWM) method on the basis of a light adjustment rate set by the control unit 20 described below, thereby changing the light transmissivity of the combined laser light C passing through the light adjustment unit 14 and adjusting (dimming) the combined laser light C input to the light adjustment unit 14 to desired light intensity. The light adjustment unit 14 may not be arranged at a position for receiving the combined laser light C in which the laser light R, the laser light G, and the laser light B are combined, but may be provided in each optical path of the laser light R, the laser light G, and the laser light B that are before being combined by the light combining unit 13. In addition, the light adjustment unit 14 may include reflective liquid crystal on silicon (LcoS) or the like instead of a transmissive liquid crystal element. For the light adjustment unit 14, the light adjustment rate may be set on the basis of an external illuminance detected by the external light sensor 500 described below, under the control of a light adjustment control unit (not illustrated). Specifically, for example, when the external illuminance is high (bright), the light adjustment rate of the light adjustment unit 14 is set high to display the image M with a high luminance, and when the external illuminance is low (dark), the light adjustment rate of the light adjustment unit 14 is set low to display the image M with a low luminance. Moreover, it is desirable that the light adjustment unit 14 be driven in such a manner that the same voltage is applied to a positive electrode and a negative electrode for the same period in order to prevent a burn-in of the liquid crystal element. In addition, the liquid crystal element 14a and the two polarization filters 14b and 14c in the light adjustment unit 14 may not be provided so as to be continuous on the optical path of the combined laser light C via the liquid crystal element 14a as illustrated in FIG. 3, and may be provided separately from one another. The polarization filter 14b located closer to the light source 11 than the liquid crystal element 14a may be omitted. Furthermore, the light adjustment unit 14 may be omitted.

The light branching unit 15 in FIG. 3 includes a transmissive material having a reflectance of approximately 5%, for example, and is arranged on the optical path of the combined laser light C between the light adjustment unit 14 and the scanning unit 102. Most of the combined laser light C from the light adjustment unit 14 is transmitted as is, but part of the light is reflected as a reflected light C1 in the direction of the light intensity detection unit 16 described below. The light branching unit 15 may direct the transmitted light to the light intensity detection unit 16 and the reflected light in an emission direction (direction of the scanning unit 102).

The light intensity detection unit 16 in FIG. 3 includes, for example, a photo diode or a color sensor, receives the reflected light C1 reflected by the light branching unit 15, and detects the light intensity of the received reflected light C1. The light intensity detection unit 16 includes an integrator circuit (not illustrated), and outputs a detection signal Sd in which the light intensity of the received reflected light C1 is integrated, to the control unit 20 described below. The light intensity detection unit 16 may include a variable amplifier 16a which amplifies the detection signal Sd with a variable amplification rate, between the light intensity detection unit 16 and the control unit 20.

FIG. 4 is a block diagram illustrating an electrical configuration of the laser light output unit 101 illustrated in FIG. 2. The control unit 20 of the laser light output unit 101 includes a circuit, and the circuit includes at least one semiconductor integrated circuit such as at least one processor (e.g., a central processing unit (CPU)), at least one application specific integrated circuit (ASIC), and at least one application specific integrated circuit (ASIC), and/or at least one field programmable gate array (FPGA). At least one processor reads one or more commands from at least one computer-readable and tangible recording medium, and thereby can execute all or some of the functions of the control unit 20 including the illuminance determination unit 21, the inspection time adjustment unit 22, the light source control unit 23, the gain control unit 24, the light adjustment control unit that controls the light adjustment unit 14, and the scanner control unit (not illustrated). Such recording medium includes a magnetic medium of any type such as a hard disk, an optical medium of any type such as a CD and a DVD, a semiconductor memory of any type such as a volatile memory, and a non-volatile memory. The volatile memory includes a DRAM and an SRAM, and the non-volatile memory includes a ROM and an NVROM. The semiconductor memory is also a semiconductor circuit that becomes a part of the circuit together with at least one processor. The ASIC is an integrated circuit that is customized to execute all or some of the functional blocks illustrated in FIG. 4, and the FPGA is an integrated circuit designed to execute all or some of the functional blocks illustrated in FIG. 4 after manufacturing.

The illuminance determination unit 21 inputs an external illuminance (illuminance signal) in an environment where the HUD device 1 displays the virtual image V (ambient environment of the HUD device 1), determines brightness of the ambient environment, and outputs a determination result to the inspection time adjustment unit 22. The illuminance determination unit 21 inputs, for example, the external illuminance from the external light sensor 500 provided in the HUD device 1, and determines whether the environment for displaying the virtual image V is bright or dark on the basis of this external illuminance.

As an other embodiment, the illuminance determination unit 21 may input a captured image in which the front of the vehicle 2 (the traveling direction of the vehicle 2) is captured by a camera provided in the vehicle 2 and analyze a luminance of the captured image to thereby detect the brightness of the ambient environment. That is, the “illuminance signal that allows estimation of an illuminance in an ambient environment” set forth in the claims may include an image captured by the camera. In addition, information (illuminance signal) that allows estimation of the illuminance of the ambient environment may be input by a vehicle-to-vehicle communication (V2V) or/and a road-to-vehicle communication (V2P) using a communication unit (not illustrated) that is provided in the vehicle 2. Moreover, the illuminance determination unit 21 may input a required luminance signal for controlling the luminance of the virtual image V from the vehicle 2ECU 600, and on the basis of this, may determine the brightness of the ambient environment. In this case, the illuminance determination unit 21 may determine that the ambient environment is bright when a high luminance is required by the required luminance signal.

The inspection time adjustment unit 22 controls a time (hereinafter, also referred to as a start time) ts at which the light source 11 starts emission of an inspection light Cd, or/and a time (hereinafter, also referred to as an end time) to at which the light source 11 ends the emission of the inspection light Cd, on the basis of the determination result of the illuminance determination unit 21, thereby adjusting a period Q during which the inspection light Cd is emitted. When the illuminance determination unit 21 determines that the ambient environment is dark, the inspection time adjustment unit 22 delays a start time ts of the inspection light Cd or/and advances an end start time ts of the inspection light Cd, and thereby can shorten the period Q during which the light source 11 emits the inspection light Cd, and when the illuminance determination unit 21 determines that the ambient environment is bright, the inspection time adjustment unit 22 advances the start time ts of the inspection light Cd or/and delays the end start time ts of the inspection light Cd, and thereby can lengthen the period Q during which the light source 11 emits the inspection light Cd. The inspection time adjustment unit 22 may adjust the start time ts and the end start time ts of the inspection light Cd on the basis of a signal indicating the scanning position of the scanning unit 102 acquired from the scanning unit 102 or a scanner control unit (not illustrated) that controls the scanning unit 102, a timing signal output at a timing of being at a specific scanning position, a synchronization signal for synchronizing the scanning position of the scanning unit 102 and the emission timing of the light source 11, that is output from a time adjustment unit (not illustrated), or the like.

The light source control unit 23 reads out, light source drive data provided for each of the light sources 11a, 11b, and 11c in which the emitted laser light has a different color, from a storage unit (not illustrated) to cause the light sources 11a, 11b, and 11c to emit a laser light with desired light intensity. This light source drive data is data with which a current value (an example of the control value) is associated to drive the light sources 11a, 11b, and 11c for every 8-bit 256 gradations. However, even if the light source 11 is driven with a same current value (control value), it is difficult to express a desired gradation due to changes over time in characteristics of the light source 11 and the light adjustment unit 14 and changes in characteristics due to differences in operating environments such as a temperature. In the image generation unit 100 of the present embodiment, the laser light output unit 101 emits the inspection light Cd which is a laser light for inspection, and executes a light intensity correction process to correct the light source drive data on the basis of the detection signal Sd related to the light intensity of the laser light detected by the light intensity detection unit 16 for this inspection light Cd, and it is thereby possible to express a desired gradation with each of the light sources 11, that emits a different colored light. Therefore, it is possible to display the image M with a good white balance.

In addition, the light source control unit 23 drives each of the light sources 11a, 11b, and 11c at a high gradation of the light source drive data, thereby emitting the inspection light Cd. Specifically, 90 to 100% of the gradation may be employed. The light intensity of the inspection light Cd is increased by making the inspection light Cd a light with a high gradation. Therefore, the detection signal from the light intensity detection unit 16 described below becomes large, an S/N ratio (signal-to-noise ratio) which is the ratio of a noise with respect to the detection signal can be lowered, and accurate light intensity detection is possible. The control unit 20 may include dedicated drive data for emitting the inspection light Cd, which is different from the light source drive data, in order for each of the light sources 11a, 11b, and 11c to emit the inspection light Cd. In addition, the light source control unit 23 does not have to make the light intensity of the inspection light Cd (control value for emitting the inspection light Cd) the same in accordance with the brightness of a surrounding environment determined by the illuminance determination unit 21.

Specifically, the light source control unit 23 may make, the light intensity of the inspection light Cd emitted from the light source 11 when it is determined that the ambient environment is dark, lower than the light intensity of the inspection light Cd emitted from the light source 11 when it is determined that the ambient environment is bright. As a result, the inspection light Cd becomes weaker when the surrounding environment is dark, and therefore it is possible to suppress the amount of stray light that goes to the observer 3 due to the diffusion and irregular reflection of the inspection light Cd.

The variable amplifier 16a is disposed between the control unit 20 and the light intensity detection unit 16, amplifies the detection signal Sd of the light intensity of the inspection light Cd from the light intensity detection unit 16, and the gain control unit 24 controls the amplification factor (gain) of the variable amplifier 16a. The gain control unit 24 may control the amplification factor in accordance with the length of the period Q during which the inspection light Cd is emitted. Specifically, when the period Q during which the inspection light Cd is emitted becomes short (when the illuminance determination unit 21 determines that the ambient environment is dark), the gain control unit 24 increases the amplification factor and thereby can increase the magnitude of the detection signal Sd input to the control unit 20 even if the period Q during which the inspection light Cd is emitted is short. The gain control unit 24 may set the variable amplifier 16a to have an amplification factor that is inversely proportional to the period Q during which the inspection light Cd is emitted. As a result, even if the period Q during which the inspection light Cd is emitted is different, the magnitudes of the detection signals Sd input to the control unit 20 can be made substantially uniform, the light intensity correction process for correcting the light source drive data can be made to be a common process even if there is a difference in the period Q, or a change in the light intensity correction process due to the difference in the period Q can be suppressed to be small.

Moreover, the gain control unit 24 may change the amplification factor in accordance with the light adjustment rate of the light adjustment unit 14. The light intensity of the inspection light Cd received by the light intensity detection unit 16 changes depending on the light adjustment rate of the light adjustment unit 14. When the external illuminance is high (bright), the light adjustment rate of the light adjustment unit 14 is set high to display the image M with a high luminance. Therefore, when the external illuminance is high (bright), the light intensity of the inspection light Cd received by the light intensity detection unit 16 is large. On the other hand, when the external illuminance is low (dark), the light adjustment rate of the light adjustment unit 14 is set low to display the image M with a low luminance. Therefore, the light intensity of the inspection light Cd received by the light intensity detection unit 16 is small. In the control unit 20, for example, when the light adjustment rate of the light adjustment unit 14 is set low and the light intensity of the inspection light Cd is small, the gain control unit 24 causes the variable amplifier 16a to appropriately amplify the detection signal input from the light intensity detection unit 16 to the control unit 20. As a result, even if the light intensity of the inspection light Cd is small due to the action of the light adjustment unit 14, it is possible to increase a signal strength and to detect the light intensity with high accuracy.

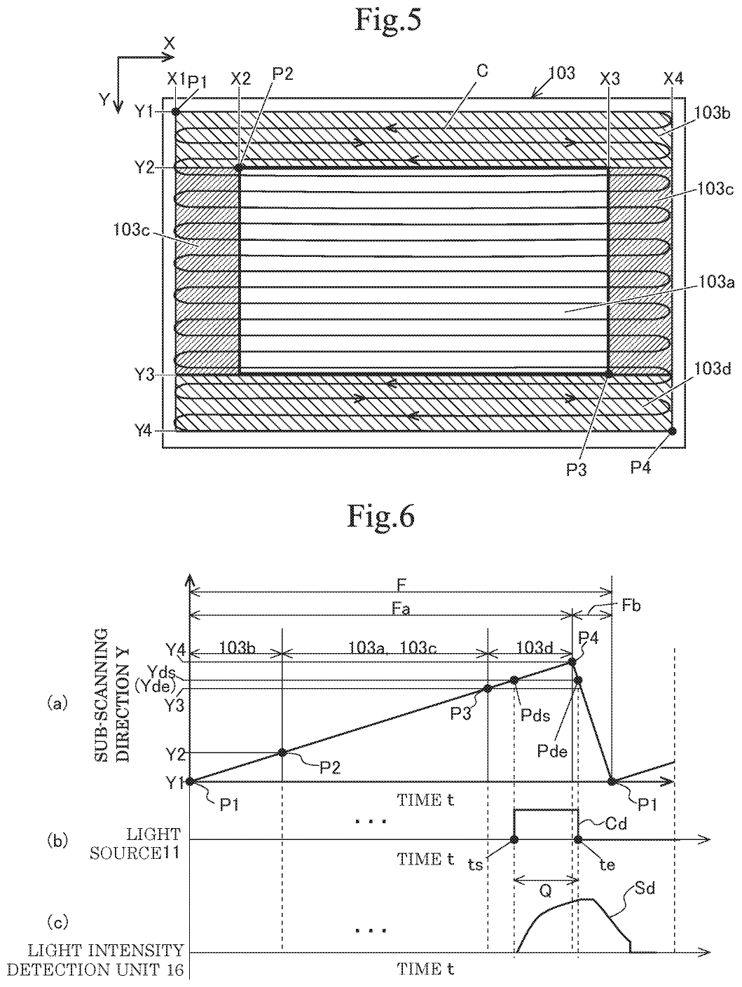

FIG. 5 is a diagram illustrating an example of an aspect in which the scanning unit 102 illustrated in FIG. 2 scans the combined laser light C on the screen 103.

The scanning unit 102 receives the combined laser light C from the laser light output unit 10, and under the control of the scanner control unit (not illustrated), scans the received combined laser light C on the screen 103 a plurality of times in a main scanning direction X while scanning in a sub-scanning direction Y, and generates the image M on the screen 103, as illustrated FIG. 5.

The screen 103 includes, for example, a holographic diffuser, a microlens array, a diffusion plate, and the like, and receives the combined laser light C scanned by the scanning unit 102 on the back side, displays the image M on the front side, and emits the display light K representing the image M from the surface toward a first reflection unit 200 (relay optical unit). In the present embodiment, the screen 103 is a transmissive type, but may be a reflective type.

The screen 103 is, classified into, for example, an effective display area 103a which is smaller than the outline of the screen 103 illustrated by the bold line frame in FIG. 5 and is an area that can be visually recognized as the virtual image V by the observer 3 (that is, an area where the combined laser light C is reflected by the first reflection unit 200 or the like and emitted to the outside as the display light K), and a non-display area (103b, 103c, and 103d) which is an area that surrounds the effective display area 103a that is filled and illustrated in FIG. 5 and is not normally visually recognized by the observer 3. This non-display area is an area adjacent to the effective display area 103a in the main scanning direction X, includes a scanning turnaround point of main scanning of the scanning unit 102, and is classified into intermittent non-display areas 103c that switch from the effective display area 103a intermittently during main scanning (right and left areas of the effective display area 103a in FIG. 5), and continuous non-display areas 103b and 103d (above and below areas of the effective display area 103a in FIG. 5) that include areas adjacent to the effective display area 103a in the sub-scanning direction Y and are areas where scan is performed outside the effective display area 103a continuously during main scanning.

FIG. 6(a) is a diagram illustrating the transition of a time t at the scanning position in the sub-scanning direction Y of the scanning unit 102. FIG. 6(b) is a diagram illustrating a time at which the light source 11 emits the inspection light Cd. FIG. 6(c) is a diagram illustrating the transition of a time t of the detection signal Sd output from the light intensity detection unit 16. The scanning unit 102 scans the combined laser light C from a scanning start position P1 of the screen 103 to a scanning end position P4, and returns the combined laser light C to the scanning start position P1 again when reaching the scanning end position P4. One frame F in which the image M is generated is classified into a scan outward path period Fa in which the image M is generated while the scanning unit 102 sub-scans in the positive direction of the sub-scanning direction Y and a scan return path period Fb in which the scanning unit 102 sub-scans in the negative direction in the sub-scanning direction Y at a high speed (the speed in the sub-scanning direction Y is faster than that in the scan outward path period Fa). That is, one frame F is a period from when the scanning position of the scanning unit 102 starts scanning from the scanning start position P1 and passes through a display start position P2 and a display end position P3, which are the ends on the effective display area 103a, and then until when the scanning position reaches the scanning end position P4 and returns to the scanning start position P1 again. One frame F is set to less than 1/60 seconds (60 Hz or more) higher than a critical fusion frequency at which a human can visually recognize flicker.

The inspection time adjustment unit 22 causes the light source 11 (one of the light sources 11a, 11b, and 11c) to start emission of the inspection light Cd at a predetermined start time is when the scanning position of the scanning unit 102 is within the continuous non-display area 103d including the turnaround point (reciprocation switching point) in the sub-scanning direction Y, and ends the emission of the inspection light Cd at an end time to after a predetermined period Q has elapsed. As illustrated in FIG. 3, the light intensity detection unit 16 detects the branched reflected light C1 (inspection light Cd) of the combined laser light C toward the scanning unit 102, which does not go to the scanning unit 102, and can detect the light intensity of the inspection light Cd regardless of the scanning position of the scanning unit 102, and outputs the detection signal Sd to the control unit 20 as an integrated value obtained by time-integrating the light intensity detected by an integrator circuit (not illustrated) (see FIG. 6). It is preferable that the integrated value in the detection signal Sd be reset (set a voltage signal to zero) before a new inspection light Cd is detected.

In addition, the inspection time adjustment unit 22 may cause to start emission of the inspection light Cd before the scanning position of the scanning unit 102 reaches a reciprocation switching position Y4 in the sub-scanning direction Y described below, and may end the emission of the inspection light Cd after the scanning position of the scanning unit 102 reaches the reciprocation switching position Y4. As a result, the scanning position of the scanning unit 102 is turn around in the sub-scanning direction Y during the period Q during which the inspection light Cd is emitted, and thus the width in the sub-scanning direction Y of the inspection light Cd scanned on the screen 103 can be reduced. The “width in the sub-scanning direction Y of the inspection light Cd scanned on the screen 103” here is the length in the sub-scanning direction Y of an area on the screen 103 where the inspection light Cd is scanned. When the period Q includes the reciprocation switching position Y4 in the sub-scanning direction Y, the “width in the sub-scanning direction Y of the inspection light Cd scanned on the screen 103” is a length from a start sub-scanning position Yds where emission of the inspection light Cd is started to the reciprocation switching position Y4 or a length from the reciprocation switching position Y4 to an end sub-scanning position Yde where the emission of the inspection light Cd is ended, whichever is longer. On the other hand, when the period Q does not include the reciprocation switching position Y4 in the sub-scanning direction Y, the “width in the sub-scanning direction Y of the inspection light Cd scanned on the screen 103” is a length from the start sub-scanning position Yds where the emission of the inspection light Cd is started to the end sub-scanning position Yde where the emission of the inspection light Cd is ended. Therefore, if the period Q is the same, the width in the sub-scanning direction Y of the inspection light Cd scanned on the screen 103 can be shorter when the period Q includes the reciprocation switching position Y4 in the sub-scanning direction Y. More preferably, the inspection time adjustment unit 22 makes the start sub-scanning position Yds where the emission of the inspection light Cd is started and the end sub-scanning position Yde where the emission of the inspection light Cd is ended in the sub-scanning direction Y substantially the same. Making the start sub-scanning position Yds and the end sub-scanning position Yde substantially the same here means that a difference between the start sub-scanning position Yds and the end sub-scanning position Yde is within 5% of the length of a scanning range Y1 to Y4 in the sub-scanning direction Y. As a result, the width in the sub-scanning direction Y of the inspection light Cd scanned on the screen 103 can be made smaller.

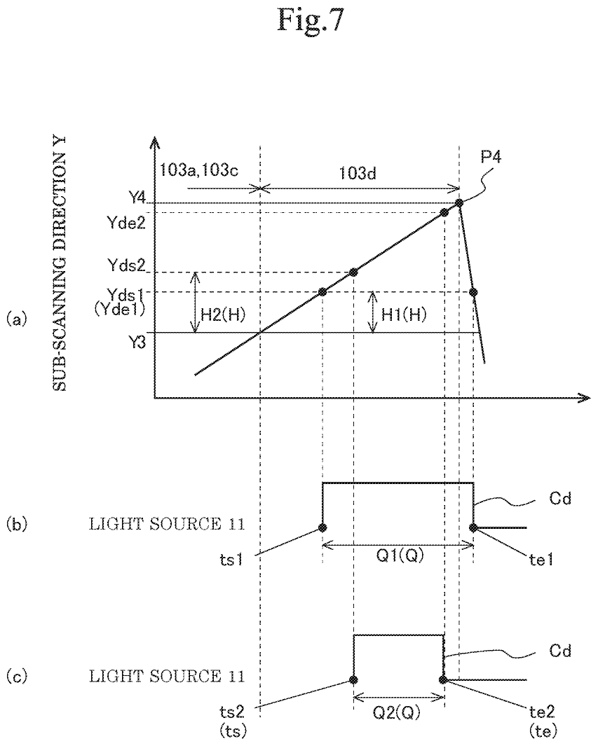

FIG. 7(a) is a diagram illustrating how the period Q during which the light source 11 emits the inspection light Cd has changed. FIG. 7(b) is a diagram illustrating the emission time of the inspection light Cd when the surroundings are bright. FIG. 7(c) is a diagram illustrating the emission time of the inspection light Cd when the surroundings are dark. When the illuminance determination unit 21 determines that the ambient environment is dark, the inspection time adjustment unit 22 shortens the period Q during which the light source 11 emits the inspection light Cd, as compared to when the ambient environment is bright (shortens from period Q1 in FIG. 7(b) to Q2 in FIG. 7(c)). Specifically, the inspection time adjustment unit 22 delays the start time ts for starting the inspection light Cd (from a start time ts1 in FIG. 7(b) to a ts2 in FIG. 7(c)), and advances the start time ts for ending the inspection light Cd (from an end time te1 in FIG. 7(b) to a te2 in FIG. 7(c)). In this case, the width in the sub-scanning direction Y of the inspection light Cd scanned on the screen 103 when the ambient environment is dark (a length from a start sub-scanning position Yds2 to an end sub-scanning position Yde2) is shorter than the width when the ambient environment is bright (a length from a start sub-scanning position Yds1 (end sub-scanning position Yde1) to the reciprocation switching position Y4). The width in the sub-scanning direction Y of the inspection light Cd scanned on the screen 103 is reduced, and thus the amount of stray light that goes to the observer 3 due to the diffusion or irregular reflection of the inspection light Cd scanned on the screen 103 can be suppressed.

In addition, a distance H from the boundary (sub-scanning position Y3) of the effective display area 103a in the sub-scanning direction Y to the area where the inspection light Cd is irradiated is a distance H1 from the start sub-scanning position Yds1 (end sub-scanning position Yde1) to a display end sub-scanning position Y3 when the ambient environment is bright, whereas the distance H is a distance 112 from the start sub-scanning position Yds2 to the display end sub-scanning position Y3 and is longer when the ambient environment is dark. That is, the area irradiated with the inspection light Cd when it is dark moves away from the effective display area 103a compared to when it is bright. The irradiation area of the inspection light Cd scanned on the screen 103 moves away from the effective display area 103a, and thus stray light due to the diffusion or irregular reflection of the inspection light Cd scanned on the screen 103 is less likely to be directed to the observer 3. The inspection time adjustment unit 22 can reliably increase the distance H between the effective display area 103a and the area where the inspection light Cd is irradiated, and therefore it is preferable to delay the start time ts for starting the inspection light Cd and advance the start time ts for ending the inspection light Cd as illustrated in FIG. 7(c). However, the present invention is not limited to this. When the illuminance determination unit 21 determines that the ambient environment is dark, the inspection time adjustment unit 22 may execute either the process for delaying the start time ts for starting the inspection light Cd or the process for advancing the start time ts for ending the inspection light Cd.

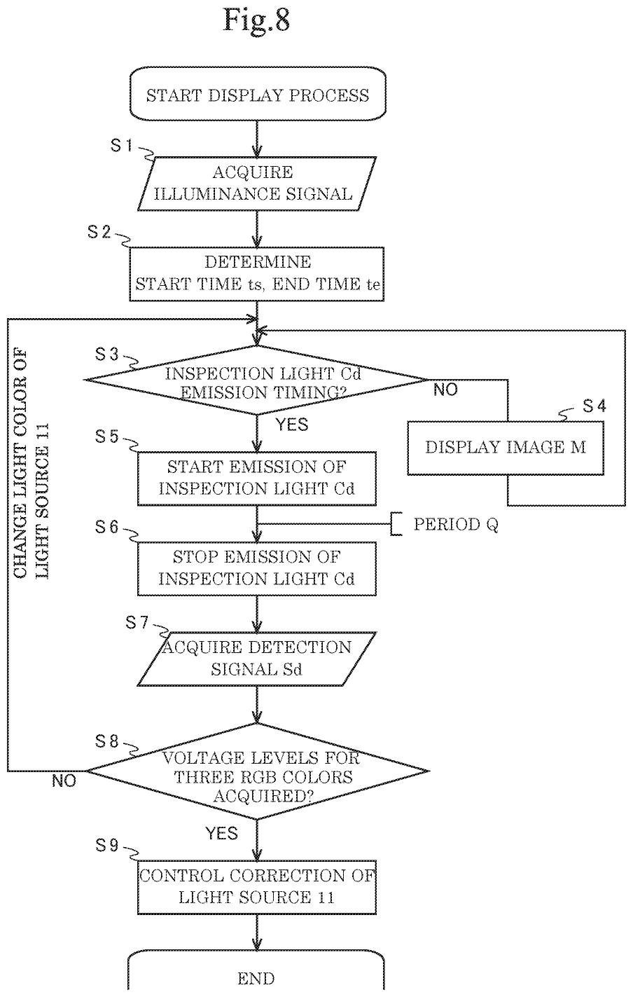

FIG. 8 is a flowchart of the “light intensity correction process” performed by the image generation unit 100 of the present embodiment.

In step S1, the illuminance determination unit 21 acquires an external illuminance from the external light sensor 500 provided in the HUD device 1, and determines whether an environment in which the virtual image V is displayed is bright or dark on the basis of this external illuminance.

In step S2, the inspection time adjustment unit 22 delays the start time ts of the inspection light Cd of the light source 11 or/and advances the end start time ts of the inspection light Cd on the basis of the determination result of the illuminance determination unit 21 when the ambient environment is dark, thereby shortening the period Q during which the inspection light Cd is emitted. The adjustment of the start time ts and the end start time ts performed by the inspection time adjustment unit 22 may be a two-step adjustment in the light and dark of the ambient environment, and the adjustment may be performed in three or more steps in a stepwise or continuous manner in accordance with the brightness of the ambient environment. The inspection time adjustment unit 22 may read out the start time ts and the end start time ts from the storage unit (not illustrated) in accordance with the brightness of the ambient environment, or the start time ts and the end start time ts may be obtained by calculating on the basis of the brightness of the ambient environment.

In step S3, the inspection time adjustment unit 22 determines whether the start time ts of the inspection light Cd determined in step S2 has come (or determines whether the scanning position of the scanning unit 102 has reached a start position Pds corresponding to the start time ts). When it cannot be determined that the start time ts (start position Pds) of the inspection light Cd has come (No in step S3), the light source control unit 23 proceeds to step S4, causes the light source 11 to output the combined laser light C for generating the image M, and generates the image M on the effective display area 103a of screen 103.

In addition, when the inspection time adjustment unit 22 determines that the start time ts (start position Pds) of the inspection light Cd has come (Yes in step S3), the light source control unit 23 proceeds to step S5 and causes the light source 11 to start emission of the inspection light Cd at a disclosure time ts (start position Pds) determined in step S2.

In step S6, the light source control unit 23 causes the inspection light to be emitted in the period Q between the start time ts and the end time to determined by the inspection time adjustment unit 22 in step S2, and then stops the emission of the inspection light Cd, and proceeds to step S7. The light source control unit 23 acquires the detection signal Sd of the inspection light Cd from the light intensity detection unit 16 (or the light intensity detection unit 16 via the variable amplifier 16a) and stores the detection signal Sd in the storage unit. The gain control unit 24 may change the amplification factor of the variable amplifier 16a in accordance with the period Q during which the inspection light Cd is emitted while the inspection light Cd is emitted in steps S5 to S6.

In step S8, the light source control unit 23 determines whether the detection signals Sd of all the colored light RGB have been acquired. If the light source control unit 23 determines that the detection signals Sd of all the colored light RGB have not been acquired (NO in step S8), the process returns to step S3 in order to detect the light source 11 of different light colors. In addition, if the light source control unit 23 determines that the detection signals Sd of all the colored light RGB have been acquired (YES in step S8), the control unit 20 (light source control unit 23) proceeds to step S9, and corrects the light source drive data of each of the light sources 11a, 11b, and 11c in such a manner that the image M suitable for the external illuminance can be displayed with a desired luminance and a desired white balance. Specifically, for example, the light source control unit 23 corrects a control value associated with a gradation at which the inspection light Cd in the light source drive data is emitted, on the basis of the detection signal Sd of the inspection light Cd emitted at a high gradation of 90 to 100% of the gradation of the light source drive data. Then, on the basis of the correction amount of the control value associated with the gradation at which this inspection light Cd is emitted, the light source control unit 23 also corrects a control value associated with an other gradation. As a result, new light source drive data is generated. Switching between the old and new light source drive data is preferably performed at a timing when the scanning position of the scanning unit 102 is in the continuous non-display area 103d. Moreover, the light source control unit 23 may detect not only the light intensity of the inspection light Cd having only one gradation but also the light intensity of the inspection light Cd having a plurality of gradations other than the one gradation, and may generate new light source drive data on the basis of the detection signals Sd of the plurality of inspection lights Cd in each of the light sources 11a, 11b, and 11c.

The acquisition of the detection signal Sd based on the light intensity by steps S5 to S7 can be performed for a plurality of colors per frame F, but it is desirable to perform the acquisition for each color.

[Variation 1] The present invention is not limited to the above embodiment and drawings. Modifications (including deletion of components) may be appropriately added to the embodiment and drawings without departing from the scope of the present invention. Below is an example of a variation.

In the above embodiment, the drive (light source drive data) of each of the light sources 11a, 11b, and 11c is corrected on the basis of the detection signal Sd from the light intensity detection unit 16, and the luminance and white balance of the image M are thereby adjusted. However, as an alternative to the correction of the light source drive data, or in addition to the correction of the light source drive data, the drive of the light adjustment unit 14 may be corrected on the basis of the detection signal from the light intensity detection unit 16, and the luminance and white balance of the image M may be thereby adjusted.

In addition, the light adjustment unit 14 may be included not on the optical path of the combined laser light C but on each of the laser lights B, G, and R that are before being combined. With such a configuration, the laser lights B, G, and R can be controlled individually.

Moreover, the emission time of the inspection light Cd may be determined on the basis of information regarding the scanning position from the scanning unit 102, may be determined on the basis of a drive signal for driving the light source 11, or may be determined on the basis of vehicle information input from the vehicle 2 or a timing for inputting an image signal.

Furthermore, in the above embodiment, the light detection is performed while generating the image M with the use of a transmissive film (light branching means), but the light intensity detection unit 16 may be arranged at a position where the light intensity of the laser light scanned in the non-display area (103b, 103c, and 103d) which is an area in the screen 103 that is not normally visually recognized by the observer 3 is received. In this case, a light guide unit (not illustrated) that includes a translucent resin material or the like for guiding the light of the area irradiated with the inspection light Cd to the light intensity detection unit 16 may be provided.

### DESCRIPTION OF REFERENCE NUMERALS

1 HUD device
3 observer
10 laser light output unit
11 light source
11a first light source
11b second light source
11c third light source
12 light condensing unit
13 light combining unit
14 light adjustment unit
15 light branching unit
16 light intensity detection unit
16a variable amplifier
20 control unit
21 illuminance determination unit
22 inspection time adjustment unit
23 light source control unit
24 gain control unit
100 image generation unit
101 laser light output unit
102 scanning unit
103 screen
103a effective display area
103b continuous non-display area
103c intermittent non-display area
103d continuous non-display area
200 first reflection unit
300 second reflection unit
400 housing
410 light transmission unit
500 external light sensor
600 vehicle ECU
C combined laser light
C1 reflected light
Cd inspection light
F one frame
Fa scan outward path period
Fb scan return path period
H distance
H1 distance
H2 distance
K display light
M image
P1 scanning start position
P2 display start position
P3 display end position
P4 scanning end position
Pds start position
Q period
Q1 period
Sd detection signal
V virtual image
X main scanning direction
Y sub-scanning direction

1. A laser light output control device (101) to provide feedback on light intensity of a laser light emitted by a light source (11) to thereby adjust a control value of the light source (11), for displaying an image (M), the laser light output control device (101) comprising:
an illuminance determination unit (21) that acquires an illuminance signal allowing estimation of illuminance in an ambient environment or a required luminance signal externally controlling luminance of the image (M) and determines brightness of the ambient environment;
an inspection time adjustment unit (22) that shortens a period (Q), during which the light source (11) emits an inspection light (Cd), when the illuminance determination unit (21) determines that the ambient environment is dark, compared to when the ambient environment is bright; and
a light source control unit (23) that acquires an integrated value (Sd) of light intensity of the inspection light (Cd) emitted by the light source (11) and adjusts the control value that drives the light source (11).

2. The laser light output control device according to claim 1, wherein the inspection time adjustment unit (22) advances a timing (te) for ending emission of the inspection light (Cd) when the ambient environment is dark, compared to when the ambient environment is bright.

3. The laser light output control device according to claim 1, wherein the light source control unit (23) makes intensity of the inspection light (Cd), which is emitted from the light source (11) when it is determined that the ambient environment is dark, lower than the intensity of the inspection light (Cd), which is emitted from the light source (11) when it is determined that the ambient environment is bright.

4. The laser light output control device according to claim 1, further comprising a gain control unit (24) that changes a gain of a variable amplifier (16) amplifying the integrated value of the light intensity,
wherein the gain control unit (24) sets the gain in inverse proportion to the period (Q) during which the inspection light (Cd) is emitted.

5. A laser scanning display device comprising:
the laser light output control device (20) according to claim 1;
a light source (11) for which the control value is adjusted by the laser light output control device (20); and
a scanning unit (102) that scans the laser light emitted from the light source (11) in a sub-scanning direction (Y) substantially orthogonal to a main scanning direction (X) while scanning the laser light a plurality of times in the main scanning direction (X), to thereby generate the image (M).

6. The laser scanning display device according to claim 5, wherein the inspection time adjustment unit (22) causes emission of the inspection light (Cd) to start before a scanning position of the scanning unit (102) reaches a reciprocation switching position (Y4) in the sub-scanning direction (Y), and causes the emission of the inspection light (Cd) to end after the scanning position reaches the reciprocation switching position.

7. The laser light output control device according to claim 2, wherein the light source control unit (23) makes intensity of the inspection light (Cd), which is emitted from the light source (11) when it is determined that the ambient environment is dark, lower than the intensity of the inspection light (Cd), which is emitted from the light source (11) when it is determined that the ambient environment is bright.
